(19) United States
(12) Patent Application Publication
(10) Pub. No.: US 2023/0240346 A1
(43) Pub. Date: Aug. 3, 2023

(54) METHOD FOR ENHANCING SALTINESS OF FOOD

(71) Applicant: AJINOMOTO CO., INC., Tokyo (JP)

(72) Inventors: Takuya SUGO, Kawasaki-shi (JP); Naoko HISHIYA, Kawasaki-shi (JP); Tomohiro SAKAMOTO, Kawasaki-shi (JP)

(73) Assignee: AJINOMOTO CO., INC., Tokyo (JP)

(21) Appl. No.: 18/296,029

(22) Filed: Apr. 5, 2023

Related U.S. Application Data
(63) Continuation of application No. PCT/JP2021/038877, filed on Oct. 21, 2021.

(30) Foreign Application Priority Data
Oct. 22, 2020 (JP) 2020-177585

(51) Int. Cl. A23L 27/00; A23L 27/21; A23L 27/23

(52) U.S. Cl. CPC A23L 27/88; A23L 27/21; A23L 27/235

(57) ABSTRACT

Provided is a technology to enhance the saltiness of food. The saltiness of food is enhanced by adding the following ingredients (A) to (D): (A) potassium chloride; (B) arginine or a salt thereof; (C) lysine or a salt thereof; and (D) a nucleic acid-containing yeast extract.

### TECHNICAL FIELD

The present invention relates to technology for enhancing the saltiness of food.

### BACKGROUND ART

The recent health consciousness places importance on the reduction of salt intake. Known technologies for reducing salt include, for example, a technology for enhancing the saltiness using salt substitutes. Known examples of the salt substitutes include potassium salts such as potassium chloride and ammonium salts such as ammonium chloride. However, these salt substitutes usually have the disadvantage of exhibiting an unusual taste, such as bitterness.

Patent Document 1 discloses a composition for low-salt food and drink, containing a vegetable protein hydrolysate and a yeast extract. Patent Document 1 also illustrates amino acids such as arginine and lysine as ingredients that can be contained in the composition.

Patent Document 2 discloses a saltiness enhancing agent containing arginine, lysine hydrochloride, potassium chloride, and proline.

Patent Document 3 discloses a saltiness enhancing agent containing enzymatic degradation products of animal protein and soybean protein. Patent Document 4 also illustrates potassium chloride, and basic amino acids such as arginine and lysine as ingredients that can be contained in the saltiness enhancing agent.

Patent Document 4 discloses a composite amino acid seasoning composition containing L-glutamic acid, L-lysine, and L-arginine. Patent Document 5 also illustrates nucleic acids and yeast extracts as ingredients that can be contained in the composition.

Patent Document 5 discloses a salt substitute containing a potassium salt, an ammonium salt, and a nucleic acid-containing yeast extract. Patent Document 6 also illustrates potassium chloride as the potassium salt.

Patent Document 6 discloses a seasoning composition containing sodium chloride, potassium chloride, a glutamate salt, and a nucleic acid taste substance.

### PRIOR ART DOCUMENTS

PATENT DOCUMENTS

| | |
|---|---|
| Patent Document 1: | JP 2011-004668 A |
| Patent Document 2: | JP 2019-165640 A |
| Patent Document 3 | JP 2011-010657 A |
| Patent Document 4 | JP 2016-165297 A |
| Patent Document 5 | JP 2011-501948 A |
| Patent Document 6 | JP 58-94368 A |

### SUMMARY OF THE INVENTION

### Problems to be Solved by the Invention

The present invention aims to provide a technology for enhancing the saltiness of food.

### Means for Solving the Problems

The present inventors have found that addition of potassium chloride, arginine, lysine, and a nucleic acid-containing yeast extract can enhance the saltiness of food, thereby completing the present invention.

Accordingly, the present invention can be illustrated as follows.

[1] A composition for enhancing saltiness of food, the composition comprising the following ingredients (A) to (D):

(A) potassium chloride;

(B) arginine or a salt thereof;

(C) lysine or a salt thereof; and

(D) a nucleic acid-containing yeast extract.

[2] A composition for reducing salt in food, the composition comprising the following ingredients (A) to (D):

(A) potassium chloride;

(B) arginine or a salt thereof;

(C) lysine or a salt thereof; and

(D) a nucleic acid-containing yeast extract.

[3] A composition for producing food, the composition comprising the following ingredients (A) to (D):

(A) potassium chloride;

(B) arginine or a salt thereof;

(C) lysine or a salt thereof; and

(D) a nucleic acid-containing yeast extract.

[4] The composition mentioned above, wherein the food to be produced is food with enhanced saltiness.
[5] The composition mentioned above, wherein the enhancement of the saltiness is enhancement of the saltiness in the initial taste.
[6] The composition mentioned above, wherein the food to be produced is food with reduced salt.
[7] The composition mentioned above, wherein the nucleic acid contained in the nucleic acid-containing yeast extract is inocinic acid or a salt thereof and/or guanylic acid or a salt thereof.
[8] The composition mentioned above, wherein the inocinic acid or the salt thereof is disodium inosinate, and the guanylic acid or the salt thereof is disodium guanylate.
[9] The composition mentioned above, wherein the amount of the nucleic acid contained in the nucleic acid-containing yeast extract is 10% (w/w) or more.
[10] The composition mentioned above, wherein the lysine or the salt thereof is lysine hydrochloride.
[11] The composition mentioned above, wherein the amount of the ingredient (D) contained in the composition is 2.3 to 50% (w/w) relative to the total amount of the ingredients (A) to (C) contained in the composition.
[12] A method of enhancing saltiness of food, the method comprising:

a step of adding the following ingredients (A) to (D) to a raw material of the food:

(A) potassium chloride;

(B) arginine or a salt thereof;

(C) lysine or a salt thereof; and

(D) a nucleic acid-containing yeast extract.

[13] A method of reducing salt in food, the method comprising:

a step of enhancing saltiness of the food by the method mentioned above.

[14] A method of producing food with reduced salt, the method comprising:

a step of enhancing the saltiness of the food by the method mentioned above.

[15] A method of reducing salt in food, the method comprising:

a step of adding the following ingredients (A) to (D) to a raw material of the food:

(A) potassium chloride;

(B) arginine or a salt thereof;

(C) lysine or a salt thereof; and

(D) a nucleic acid-containing yeast extract.

[16] A method of producing food, the method comprising:

a step of adding the following ingredients (A) to (D) to a raw material of the food:

(A) potassium chloride;

(B) arginine or a salt thereof;

(C) lysine or a salt thereof; and

(D) a nucleic acid-containing yeast extract.

[17] The method mentioned above, wherein the food to be produced is food with enhanced saltiness.
[18] The method mentioned above and 17, wherein the enhancement of the saltiness is enhancement of the saltiness in the initial taste.
[19] The method mentioned above, wherein the food to be produced is food with reduced salt.
[20] The method mentioned above, wherein the nucleic acid contained in the nucleic acid-containing yeast extract is inocinic acid or a salt thereof and/or guanylic acid or a salt thereof.
[21] The method mentioned above, wherein the inocinic acid or the salt thereof is disodium inosinate, and the guanylic acid or the salt thereof is disodium guanylate.
[22] The method mentioned above, wherein the amount of the nucleic acid contained in the nucleic acid-containing yeast extract is 10% (w/w) or more.
[23] The method mentioned above, wherein the lysine or the salt thereof is lysine hydrochloride.
[24] The method mentioned above, wherein the amount of the ingredient (D) added is 2.3 to 50% (w/w) relative to the total amount of the ingredients (A) to (C) added.
[25] The method mentioned above, which comprises one, two, three, or four features selected from the group consisting of the following (a) to (d):

(a) the ingredient (A) is added so that the concentration of the ingredient (A) at the time of eating is 0.0024 to 0.12% (w/w);

(b) the ingredient (B) is added so that the concentration of the ingredient (B) at the time of eating is 0.0005 to 0.025% (w/w);

(c) the ingredient (C) is added so that the concentration of the ingredient (C) at the time of eating is 0.000048 to 0.0024% (w/w); and

(d) the ingredient (D) is added so that the concentration of the ingredient (D) at the time of eating is 0.00014 to 0.007% (w/w).

[26] The method mentioned above, wherein the ingredients (A) to (D) are added by addition of the composition mentioned above.
[27] Food with reduced salt, the food containing the composition mentioned above.
[28] The food mentioned above, which has one, two, three, or four features selected from the group consisting of the following (a) to (d):

(a) the ingredient (A) is contained so that the concentration of the ingredient (A) at the time of eating is 0.0024 to 0.12% (w/w);

(b) the ingredient (B) is contained so that the concentration of the ingredient (B) at the time of eating is 0.0005 to 0.025% (w/w);

(c) the ingredient (C) is contained so that the concentration of the ingredient (C) at the time of eating is 0.000048 to 0.0024% (w/w); and

(d) the ingredient (D) is contained so that the concentration of the ingredient (D) at the time of eating is 0.00014 to 0.007% (w/w).

### DETAILED DESCRIPTION OF THE INVENTION

### <1> Active Ingredient

In the present invention, the following ingredients (A) to (D) are used as active ingredients:

(A) potassium chloride;

(B) arginine;

(C) lysine; and

(D) a nucleic acid-containing yeast extract.

The ingredients (A) to (D) described above are also collectively referred to as “active ingredients”.

Note that the arginine (ingredient (B)) may be read as arginine or a salt thereof. In addition, the lysine (ingredient (C)) may be read as lysine or a salt thereof. In other words, in the present invention, the following ingredients (A) to (D) may be used as active ingredients:

(A) potassium chloride;

(B) arginine or a salt thereof;

(C) lysine or a salt thereof; and

(D) a nucleic acid-containing yeast extract.

The active ingredients can be used to enhance the saltiness of food, i.e., obtain an effect of enhancing the saltiness of food. The effect is also referred to as “saltiness enhancement effect”. Enhancement of the saltiness of food is also simply referred to as “enhancement of the saltiness”. That is, the active ingredients can be used to enhance the saltiness of food as compared with the case where the active ingredients are not used. The phrase “the active ingredients are not used” may mean that at least one ingredient selected from the ingredients (A) to (D) is not used, and also includes the case where none of the ingredients (A) to (D) is used. That is, the ingredients (A) to (D) may be used to enhance the saltiness of food as compared with the case where at least one ingredient selected from the ingredients (A) to (D) is not used. For example, the ingredients (A) to (D) may be used to enhance the saltiness of food as compared with the case where the ingredient (D) is not used (i.e., the case where only the ingredients (A) to (C) are used). Thus, the active ingredients may be used for enhancement of the saltiness of food.

In addition, the active ingredients can be used to produce food with enhanced saltiness. Thus, the active ingredients may be used in production of food (specifically, production of food with enhanced saltiness).

The enhancement of the saltiness is not limited to enhancement of the saltiness of food with saltiness, and also includes impartment of saltiness to food without saltiness. The terms “impartment of saltiness” and “enhancement of the saltiness” may be used interchangeably.

The enhancement of the saltiness includes enhancement of the saltiness in the initial taste. In addition to the saltiness in the initial taste, the use of the active ingredients may or may not enhance, for example, the saltiness in the middle taste and/or saltiness in the aftertaste. The terms “saltiness in the initial taste”, “saltiness in the middle taste”, and “saltiness in the aftertaste” in the case of liquids (i.e., liquid foods) means the saltiness felt between 0 seconds and 1 second, between 1 second and 3 seconds, and between 3 seconds and 5 seconds after eating (i.e., after putting food in mouth), respectively. The terms “saltiness in the initial taste”, “saltiness in the middle taste”, and “saltiness in the aftertaste” in the case of solids (i.e., solid foods) means the saltiness felt between 0 seconds and 4 seconds, between 4 seconds and 10 seconds, and between 10 seconds and 15 seconds after eating (i.e., after putting food in mouth), respectively. The term “solid” may mean other forms than liquid, and may include, for example, paste. The saltiness in the initial taste, the saltiness in the middle taste, and the saltiness in the aftertaste are also referred to as “early saltiness”, “middle saltiness”, and “later saltiness”, respectively. The active ingredients may be used to, for example, selectively enhance the saltiness in the initial taste. The phrase “selectively enhanced saltiness in the initial taste” may mean that the degree of the enhancement of the saltiness in the initial taste is larger than the degree of the enhancement of the saltiness in the middle taste and larger than the degree of the enhancement of the saltiness in the aftertaste. The degree of the enhancement of the saltiness may be the ratio of the increment in the intensity of the saltiness achieved by adding active ingredients to a negative control to the difference between the intensities of the saltiness of a positive control with respect to the saltiness (for example, food containing a normal amount of sodium chloride) and a negative control (for example, the same type of food as the positive control which contains a lower amount of sodium chloride than the positive control). Measurement and comparison of the saltiness can be performed, for example, by sensory evaluation with an expert panel.

The enhancement of the saltiness may be used, for example, for reduction of salt in food. Specifically, enhancement of the saltiness can compensate lack of the saltiness of food due to reduction of salt, thereby achieving reduction of salt in food. That is, in one aspect, reduction of salt in food can be performed by using the active ingredients (specifically, enhancing of the saltiness of food by using the active ingredients). In another aspect, food with reduced salt can be produced by using the active ingredients (specifically, enhancing the saltiness of food by using the active ingredients). Thus, the active ingredients may be used for reduction of salt in food and may be used for production of food (specifically, production of food with reduced salt). The reduction of salt in food and food with reduced salt are described later.

The active ingredients may be used for enhancement of the saltiness, reduction of salt in food, or production of food in aspects described in the method of the present invention described later.

### (1) Ingredient (A)

The ingredient (A) is potassium chloride.

### (2) Ingredients (B) and (C)

The ingredients (B) and (C) are arginine and lysine, respectively. The ingredients (B) and (C) are also collectively referred to as “amino acids”.

Unless otherwise noted, the amino acids may be D-forms, L-forms, or a combination thereof. The ratio of D-forms and L-forms in the combination is not particularly limited. The ratio of D-forms or L-forms in the combination may be, for example, 20 to 80%, 30 to 70%, 40 to 60%, or 45 to 55% by mole. In particular, the amino acids may be L-forms. Note that when a D- or L-amino acid is selected, it is sufficient that the D- or L-amino acid is used as an active ingredient, and it does not preclude further use of the L- or D-amino acid in combination. In this case, the L- or D-amino acid to be used in combination (i.e., one that is not selected as an active ingredient) is considered not to correspond to an active ingredient (i.e., considered as other ingredient than the active ingredients).

As the amino acids, commercially available products may be used, or those obtained by being produced as appropriate may be used. The methods of producing the amino acids are not particularly limited. The amino acids can be produced, for example, by known methods. Specifically, the amino acids can be produced, for example, by chemical synthesis, enzymatic reactions, fermentation methods, extraction methods, or a combination thereof. The amino acids may or may not be purified to a desired degree. That is, as the amino acids, purified products may be used, or materials containing the amino acids may be used. Specific examples of the materials containing the amino acids include fermented products such as culture media, bacterial cells, culture supernatants obtained by culturing microorganisms having an ability to produce the amino acids; agricultural, marine and livestock products containing the amino acids; and processed products thereof. The processed products may be those obtained by subjecting fermented products or other materials as described above to processing such as concentration, dilution, drying, fractionation, extraction, or purification. As the amino acids, for example, materials containing the amino acids in amounts of 1% (w/w) or more, 5% (w/w) or more, 10% (w/w) or more, 30% (w/w) or more, 50% (w/w) or more, 70% (w/w) or more, 90% (w/w) or more, or 95% (w/w) or more may be used.

### (3) Ingredient (D)

The ingredient (D) is a nucleic acid-containing yeast extract.

The term “nucleic acid-containing yeast extract” means a yeast extract containing a nucleic acid. The nucleic acid may be a purine nucleotide. Examples of the purine nucleotide include inocinic acid (i.e., inosine-5′-phosphate; IMP), guanylic acid (i.e., guanosine-5′-phosphate; xanthylic acid (i.e., xanthosine-5′-phosphate; XMP), and adenylic acid (i.e., adenosine-5′-phosphate; AMP). As the purine nucleotide, inocinic acid and/or guanylic acid is/are preferable, and inocinic acid and guanylic acid (i.e., a combination of inocinic acid and guanylic acid) are particularly preferable. Note that a nucleic acid (specifically, a nucleic acid contained in the nucleic acid-containing yeast extract) may be read as a nucleic acid or a salt thereof. That is, for example, inocinic acid may be read as inocinic acid or a salt thereof. In addition, for example, guanylic acid may be read as guanylic acid or a salt thereof. The nucleic acid-containing yeast extract may contain one nucleic acid, or may contain two or more nucleic acids in combination.

The term “yeast extract” may mean an extract from yeast. The form of the yeast extract is not particularly limited. The yeast extract may be in any form, for example, in liquid, powder, paste, or other form. The type of the yeast is not particularly limited. Examples of the yeast include Saccharomyces yeasts, such as Saccharomyces cerevisiae; Schizosaccharomyces yeasts, such as Schizosaccharomyces pombe; and Candida yeasts, such as such as Candida utilis. The yeast may be, in particular, a Saccharomyces yeast or a Candida yeast.

The amount of the nucleic acids contained in the nucleic acid-containing yeast extract is not particularly limited as long as a saltiness enhancement effect is obtained. The amount of the nucleic acids, in particular, the total amount of inocinic acid and guanylic acid contained in the nucleic acid-containing yeast extract with respect to the dry weight of the nucleic acid-containing yeast extract may be, for example, 10% (w/w) or more, 15% (w/w) or more, 20% (w/w) or more, 25% (w/w) or more, or 30% (w/w) or more, or may be 50% (w/w) or less, 45% (w/w) or less, 40% (w/w) or less, 35% (w/w) or less, or 30% (w/w) or less, or may be any non-contradictory combination thereof. Specifically, the amount of the nucleic acids, in particular, the total amount of inocinic acid and guanylic acid contained in the nucleic acid-containing yeast extract with respect to the dry weight of the nucleic acid-containing yeast extract may be, for example, 10 to 50% (w/w), 15 to 40% (w/w), or 20 to 35% (w/w). As the nucleic acid-containing yeast extract, one yeast extract may be used, or two or more yeast extracts may be used in combination.

When the nucleic acid-containing yeast extract contains two or more nucleic acids, the ratio of the amounts of the nucleic acids is not particularly limited. For example, when the nucleic acid-containing yeast extract contains inocinic acid and guanylic acid, the weight ratio of the amounts of inocinic acid and guanylic acid contained (inocinic acid:guanylic acid) may be 1:0.1 to 10, preferably 1:0.5 to 3, and more preferably 1:0.8 to 1.2.

As the nucleic acid-containing yeast extract, a commercially available product may be used, or one obtained by being produced as appropriate may be used. The method of producing the nucleic acid-containing yeast extract is not particularly limited. The nucleic acid-containing yeast extract can be produced, for example, by known methods. Specifically, the nucleic acid-containing yeast extract can be produced, for example, by processing a nucleic acid-containing yeast, such as high RNA-containing yeast, into a yeast extract (WO2009/110507). For the processing of yeast into a yeast extract, for example, an autolysis method, an acid hydrolysis method, an enzymatic hydrolysis method, or a combination thereof can be used for the production.

When an active ingredient can form a salt, the active ingredient may be used as a free form, or as a salt, or as a combination thereof. That is, unless otherwise noted, the term “active ingredient” may mean an active ingredient in a free form, or a salt thereof, or a combination thereof. In addition, the term “active ingredient or a salt thereof” may mean one or both of an active ingredient in a free form and a salt thereof. In other words, the term may mean an active ingredient in a free form, or a salt thereof, or a combination thereof. When an active ingredient can form a hydrate, the active ingredient may be used as a non-hydrate, or as a hydrate, or as a combination thereof. That is, unless otherwise noted, the term “active ingredient” (for example, “active ingredient in a free form” or “a salt of an active ingredient”) may include a non-hydrate and a hydrate. The active ingredients may be in any forms, such as ionic forms, when being used. The description on the forms of the active ingredients can also be applied correspondingly to the nucleic acids contained in the ingredient (D). The description on the forms of the active ingredients can also be applied correspondingly to other ingredients than the active ingredients.

The salts are not particularly limited as long as they can be taken orally. Specific examples of salts of acidic groups, such as a carboxyl group, include ammonium salts; salts with alkaline metals, such as sodium and potassium; salts with alkaline earth metals, such as calcium and magnesium; aluminum salts; zinc salts; and salts with organic amines, such as triethylamine, ethanolamine, morpholine, pyrrolidine, piperidine, piperazine, and dicyclohexylamine. Specific examples of salts of basic groups, such as an amino group, include salts with inorganic acids, such as hydrochloric acid, sulfuric acid, phosphoric acid, nitric acid, and hydrobromic acid; salts with organic carboxylic acids, such as acetic acid, citric acid, benzoic acid, maleic acid, fumaric acid, tartaric acid, succinic acid, tannic acid, butyric acid, hibenzic acid, pamoic acid, enanthic acid, decanoic acid, teoclic acid, salicylic acid, lactic acid, oxalic acid, mandelic acid, malic acid, methylmalonic acid, and adipic acid; and salts with organic sulfonic acids, such as methanesulfonic acid, benzenesulfonic acid, and p-toluenesulfonic acid. Specific examples of salts of lysine include lysine hydrochloride. Specific examples of salts of nucleic acids include sodium salts. Examples of sodium salts of inocinic acid include disodium inosinate. Examples of salts of guanylic acid include disodium guanylate. As the salt, one salt may be used, or two or more salts may be used in combination.

Note that the amount of an active ingredient (for example, the amount contained (concentration) or the amount used) when a material containing the active ingredient is used will be calculated based on the amount of the active ingredient itself in the material. The amount of an active ingredient (for example, the amount contained (concentration) or the amount used) when the active ingredient forms a salt or hydrate will be calculated based on the value obtained by converting the mass of the salt or hydrate into the mass of an equimolar of unhydrated free form. Similarly, with respect to a nucleic acid contained in the ingredient (D), the amount of the nucleic acid (for example, the amount contained (concentration) or the amount used) when the nucleic acid forms a salt or hydrate will be calculated based on the value obtained by converting the mass of the salt or hydrate into the mass of an equimolar of unhydrated free form. The amount of the yeast extract (for example, the amount contained (concentration) or the amount used) will be calculated based on the dry weight of the yeast extract.

### <2> Composition of Present Invention

The composition of the present invention is a composition containing active ingredients.

That is, the composition of the present invention is a composition containing the following ingredients (A) to (D):

(A) potassium chloride;

(B) arginine;

(C) lysine; and

(D) a nucleic acid-containing yeast extract.

The composition of the present invention may be read as a composition containing the following ingredients (A) to (D):

(A) potassium chloride;

(B) arginine or a salt thereof;

(C) lysine or a salt thereof; and

(D) a nucleic acid-containing yeast extract.

The composition of the present invention can be used to enhance the saltiness of food, i.e., to obtain a saltiness enhancement effect. Thus, the composition of the present invention may be used for enhancement of the saltiness of food. That is, the composition of the present invention may be, for example, a composition for enhancing the saltiness of food.

The composition of the present invention can also be used to produce food with enhanced saltiness. Thus, the composition of the present invention may be used for production of food (specifically, production of food with enhanced saltiness). That is, the composition of the present invention may be, for example, a composition for production of food (specifically, production of food with enhanced saltiness).

In one aspect, the composition of the present invention can be used (specifically, the present invention can be used to enhance the saltiness of food) to achieve reduction of salt in food. Thus, the composition of the present invention may be used for reduction of salt in food. That is, the composition of the present invention may be, for example, a composition for reducing salt in food.

In one aspect, the composition of the present invention can be used (specifically, the composition of the present invention can be used to enhance the saltiness of food) to produce food with reduced salt. Thus, the composition of the present invention may be used for production of food (specifically, production of food with reduced salt). That is, the composition of the present invention may be, for example, a composition for production of food (specifically, production of food with reduced salt).

The composition of the present invention may be used for enhancement of the saltiness, reduction of salt in food, or production of food in aspects described in the method of the present invention described later.

The composition of the present invention may consist of active ingredients, or may contain other ingredients than active ingredients.

The other ingredients than active ingredients are not particularly limited as long as they impair the saltiness enhancement effect. The other ingredients than active ingredients can be selected as appropriate, for example, depending on various conditions such as the type of food. The other ingredients than active ingredients include ingredients that are added to foods or pharmaceuticals.

The other ingredients than active ingredients specifically include ingredients that are effective for production of food. The ingredients that are effective for production of food include raw materials of food described later.

As the other ingredients than active ingredients, one ingredient may be used, or two or more ingredients may be used in combination.

The composition of the present invention can be produced, for example, by mixing active ingredients and any other ingredients as appropriate.

The composition of the present invention may be, for example, formulated as appropriate. In formulation, additives may be used as appropriate. Examples of the additives include excipients, binders, disintegrants, lubricants, stabilizers, correctives, diluents, surfactants, and solvents. The additives can be selected as appropriate, for example, depending on various conditions such as the shape of the composition of the present invention.

The form of the composition of the present invention is not particularly limited. For example, the composition of the present invention may be in any shape, such as powder, flake, tablet, paste, or liquid.

The amounts of ingredients (i.e., active ingredients and any other ingredients) and the amount ratio therebetween contained in the composition of the present invention are not particularly limited as long as the saltiness enhancement effect is obtained. The amounts of ingredients and the amount ratio therebetween contained in the composition of the present invention can be set as appropriate depending on various conditions such as the mode of use of the composition of the present invention.

The total amount of the active ingredients contained in the composition of the present invention is more than 0% (w/w) and 100% (w/w) or less. The total amount of the active ingredients contained in the composition of the present invention may be, for example, 1% (w/w) or more, 2% (w/w) or more, 5% (w/w) or more, 10% (w/w) or more, or 20% (w/w) or more, or may be 100% (w/w) or less, 99.9% (w/w) or less, 50% (w/w) or less, 20% (w/w) or less, 10% (w/w) or less, or 5% (w/w) or less, or may be any non-contradictory combination thereof.

The amount of the ingredient (D) contained in the composition of the present invention with respect to the total amount of the ingredients (A) to (C) contained in the composition of the present invention may be, for example, 1% (w/w) or more, 1.5% (w/w) or more, 2% (w/w) or more, 2.3% (w/w) or more, 5% (w/w) or more, 10% (w/w) or more, or 20% (w/w) or more, or may be 1000% (w/w) or less, 500% (w/w) or less, 200% (w/w) or less, 100% (w/w) or less, 50% (w/w) or less, 20% (w/w) or less, or 10% (w/w) or less, or may be any non-contradictory combination thereof. The amount of the ingredient (D) contained in the composition of the present invention with respect to the total amount of the ingredients (A) to (C) contained in the composition of the present invention may be, in particular, 200% (w/w) or less, 100% (w/w) or less, or 50% (w/w) or less. The amount of the ingredient (D) contained in the composition of the present invention with respect to the total amount of the ingredients (A) to (C) contained in the composition of the present invention may be, specifically, for example, 1 to 1000% (w/w), 1.5 to 200% (w/w), or 2.3 to 50% (w/w).

The amounts of the active ingredients contained in the composition of the present invention can be set, for example, to achieve the total amount of the active ingredients and the amount ratio between the active ingredients in the composition of the present invention as described above.

The amounts of the ingredients contained in the composition of the present invention (i.e., the active ingredients and any other ingredients) can be set, for example, to achieve the amounts of the ingredients added in the method of the present invention as described later.

The ingredients contained in the composition of the present invention (i.e., the active ingredients and any other ingredients) may be mixed each other and contained in the composition of the present invention, or may be contained separately or separately in any combination in the composition of the present invention. For example, the composition of the present invention may be provided as a set of the active ingredients that are separately packaged. In such a case, the ingredients contained in the set can be used in combination as appropriate when using them.

### <3> Method of Present Invention

The method of the present invention is a method comprising a step in which active ingredients are used.

That is, the method of the present invention is a method comprising a step in which the following ingredients (A) to (D) are used:

(A) potassium chloride;

(B) arginine;

(C) lysine; and

(D) a nucleic acid-containing yeast extract.

The method of the present invention may be read as a method comprising a step in which the following ingredients (A) to (D) are used:

(A) potassium chloride;

(B) arginine or a salt thereof;

(C) lysine or a salt thereof; and

(D) a nucleic acid-containing yeast extract.

The method of the present invention, specifically, use of the active ingredients enables enhancement of the saltiness of food, i.e., obtaining a saltiness enhancement effect. Thus, the method of the present invention may be performed for enhancement of the saltiness of food. That is, the method of the present invention may be, for example, a method of enhancing the saltiness of food. The method is also referred to as “saltiness enhancing method of the present invention”.

The method of the present invention, specifically, use of the active ingredients also enables production of food with enhanced saltiness. Thus, the method of the present invention may be performed for production of food (specifically, production of food with enhanced saltiness). That is, the method of the present invention may be, for example, a method of producing food (specifically, producing food with enhanced saltiness). The method is also referred to as “method of producing food with enhanced saltiness of the present invention”.

In one aspect, the method of the present invention, specifically, use of the active ingredients (more specifically, use of the active ingredients to enhance the saltiness of food) enables reduction of salt in food. Thus, the method of the present invention may be used for reduction of salt in food. That is, the method of the present invention may be, for example, a method of reducing salt of food. The method is also referred to as “salt reduction method of the present invention”. The salt reduction method of the present invention may be, specifically, a method of reducing salt in food comprising a step in which the saltiness enhancing method of the present invention is used. The salt reduction method of the present invention may be, more specifically, a method of reducing salt in food comprising a step of enhancing the saltiness of food by the saltiness enhancing method of the present invention.

In one aspect, the method of the present invention, specifically, use of the active ingredients (more specifically, use of the active ingredients to enhance the saltiness of food) also enables production of food with reduced salt. Thus, the method of the present invention may be used for production of food (specifically, production of food with reduced salt). That is, the method of the present invention may be, for example, a method of producing food (specifically, producing food with reduced salt). The method is also referred to as “method of producing food with reduced salt of the present invention”. The method of producing food with reduced salt of the present invention may be, specifically, a method of producing food (specifically, producing food with reduced salt) comprising a step in which the saltiness enhancing method of the present invention is used. The method of producing food with reduced salt of the present invention may be, more specifically, a method of producing food (specifically, producing food with reduced salt) comprising a step of enhancing the saltiness of food by the saltiness enhancing method of the present invention.

The active ingredients can be used for enhancement of the saltiness, reduction of salt in food, or production of food by adding them to a raw material of food in production of food. That is, examples of the use of the active ingredients include adding the active ingredients to a raw material of food. That is, the method of the present invention may be, specifically, for example, a method of enhancing the saltiness of food, comprising adding the active ingredients to a raw material of food. The method of the present invention may also be, specifically, for example, a method of producing food (specifically, producing food with enhanced saltiness), comprising adding the active ingredients to a raw material of food. The term “adding” is also referred to as “mixing”.

The active ingredients may be used in the method of the present invention, for example, in a form of a composition of the present invention. That is, “use of the active ingredients” includes the use of the composition of the present invention. For example, “addition of the active ingredients” includes addition of the composition of the present invention.

Food obtained by the method of the present invention is also referred to as “food of the present invention”. The food of the present invention is, specifically, food with enhanced saltiness. When the method of the present invention is used for reduction of salt in food, the food of the present invention is also, specifically, food with reduced salt. In other words, the food of the present invention is also food to which the active ingredients have been added, or is also food containing the active ingredients.

The enhancement of the saltiness, reduction of salt in food, or production of food may be performed, for example, in the same manner as the normal production of food except that the active ingredients are used. That is, the enhancement of the saltiness, reduction of salt in food, or production of food may be performed, for example, under the same production conditions using the same raw material(s) as normal food except that the active ingredients are used. Both the raw materials of food and production conditions may also be used for enhancement of the saltiness, reduction of salt in food, or production of food after appropriate modification.

The type of the food is not particularly limited as long as it desires enhancement of the saltiness. That is, the food may be food with saltiness. Specific examples of the food include processed marine products, such as salmon flakes, spicy cod roe, salted cod roe, grilled fish, dried fish, salted squid, fish sausage, fish cakes, boiled fish, tsukudani, and canned fish; snack foods, such as potato chips, potato snacks, corn snacks, wheat snacks, rice crackers, and cubic rice crackers; noodle soups, such as udon soup, soba soup, somen soup, ramen soup, chanpon soup, and pasta sauce; rice cooked products, such as rice balls, pilaf, fried rice, mixed rice, rice porridge, and chazuke; prepared foods, such as spring rolls, shaomai, Chinese-style dumplings, curry, simmered dishes, and fried foods; processed livestock products, such as hamburgers, sausages, ham, and cheese; processed vegetable products, such as kimchi and pickles; condiments, such as soy sauce, sauces, dressings, miso, mayonnaise, and tomato ketchup; and soups, such as egg drop soup, wakame seaweed soup, shark fin soup, Chinese soup, consomme soup, curry flavored soup, suimono, miso soup, and potage soup. The food may be provided in a ready-to-eat form, or in a form that requires preparation before or during eating, such as concentrated or dried products.

The term “raw material of food” means a food material for producing food. The raw material of food is not particularly limited as long as they allow for production of food. The raw material of food can be selected as appropriate, for example, depending on various conditions such as the type of the food. Examples of the raw material of food include ingredients as illustrated above that can be usually used for production of food. Specific examples of the raw material of food include ingredients such as grains, vegetables, meats, fish, and eggs; seasoning ingredients such as sugars, inorganic salts, organic acids, nucleic acids, amino acids, and protein hydrolysates; dairy products such as milk and cheeses; spices; flavors; fats and oils; and alcohols. More specific examples of the raw material of food include sodium chloride.

The active ingredients may be added to the raw material of food during any steps in the food production process provided that the saltiness enhancement effect is obtained. That is, “raw material of food” to which the active ingredients are to be added may be that in any step in the food production process. For example, “raw material of food” to which the active ingredients are to be added may include complete food before addition of the active ingredients. The active ingredients can be added to the raw material of food directly or after being appropriately prepared into desired forms, such as solution(s). Operations to allow the active ingredients to coexist with the raw material of food may be collectively referred to as “addition of the active ingredients”. When two or more ingredients are used as active ingredients, the descriptions on the addition of the active ingredients can be independently applied to each active ingredient unless otherwise noted. When two or more ingredients are used as active ingredients, all the active ingredients may be added to the raw material of food at the same time, or may be added to the raw material of food separately or separately in any combination. When two or more ingredients are used as active ingredients, the order in which the active ingredients are added to the raw material of food is not particularly limited.

The amounts of ingredients (i.e., active ingredients and any other ingredients) and the amount ratio therebetween added in the method of the present invention are not particularly limited as long as the saltiness enhancement effect is obtained. The amounts of ingredients and the amount ratio therebetween added in the method of the present invention can be set as appropriate depending on various conditions such as the type of raw material of food and the type of the food.

Active ingredients may be added to the raw material of food, for example, such that the concentrations of the active ingredients at the time of eating are within desired ranges.

The concentration of the ingredient (A) at the time of eating may be, for example, 0.001% (w/w) or more, 0.002% (w/w) or more, 0.0024% (w/w) or more, 0.005% (w/w) or more, 0.01% (w/w) or more, 0.02% (w/w) or more, 0.05% (w/w) or more, or 0.1% (w/w) or more, or may be 2% (w/w) or less, 1% (w/w) or less, 0.5% (w/w) or less, 0.2% (w/w) or less, 0.12% (w/w) or less, 0.1% (w/w) or less, or 0.05% (w/w) or less, or may be any non-contradictory combination thereof. The concentration of the ingredient (A) at the time of eating may be, in particular, 0.5% (w/w) or less, 0.2% (w/w) or less, or 0.12% (w/w) or less. Specifically, the concentration of the ingredient (A) at the time of eating may be, for example, 0.001 to 2% (w/w), 0.002 to 0.5% (w/w), or 0.0024 to 0.12% (w/w).

The concentration of the ingredient (B) at the time of eating may be, for example, 0.0002% (w/w) or more, 0.0004% (w/w) or more, 0.0005% (w/w) or more, 0.001% (w/w) or more, 0.002% (w/w) or more, 0.004% (w/w) or more, 0.01% (w/w) or more, or 0.02% (w/w) or more, or may be 0.4% (w/w) or less, 0.2% (w/w) or less, 0.1% (w/w) or less, 0.04% (w/w) or less, 0.025% (w/w) or less, 0.02% (w/w) or less, or 0.01% (w/w) or less, or may be any non-contradictory combination thereof. The concentration of the ingredient (B) at the time of eating may be, in particular, 0.1% (w/w) or less, 0.04% (w/w) or less, or 0.025% (w/w) or less. Specifically, the concentration of the ingredient (B) at the time of eating may be, for example, 0.0002 to 0.5% (w/w), 0.0004 to 0.1% (w/w), or 0.0005 to 0.025% (w/w).

The concentration of the ingredient (C) at the time of eating may be, for example, 0.00002% (w/w) or more, 0.00004% (w/w) or more, 0.000048% (w/w) or more, 0.0001% (w/w) or more, 0.0002% (w/w) or more, 0.0004% (w/w) or more, 0.001% (w/w) or more, or 0.002% (w/w) or more, or may be 0.04% (w/w) or less, 0.02% (w/w) or less, 0.01% (w/w) or less, 0.004% (w/w) or less, 0.0024% (w/w) or less, 0.002% (w/w) or less, or 0.001% (w/w) or less, or may be any non-contradictory combination thereof. The concentration of the ingredient (C) at the time of eating may be, in particular, 0.01% (w/w) or less, 0.004% (w/w) or less, or 0.0024% (w/w) or less. Specifically, the concentration of the ingredient (C) at the time of eating may be, for example, 0.00002 to 0.05% (w/w), 0.00004 to 0.01% (w/w), or 0.000048 to 0.0024% (w/w).

The concentration of the ingredient (D) at the time of eating may be, for example, 0.00005% (w/w) or more, 0.0001% (w/w) or more, 0.00014% (w/w) or more, 0.0003% (w/w) or more, 0.0005% (w/w) or more, 0.001% (w/w) or more, 0.003% (w/w) or more, or 0.005% (w/w) or more, or may be 0.1% (w/w) or less, 0.05% (w/w) or less, 0.03% (w/w) or less, 0.01% (w/w) or less, 0.007% (w/w) or less, 0.005% (w/w) or less, or 0.003% (w/w) or less, or may be any non-contradictory combination thereof. The concentration of the ingredient (D) at the time of eating may be, in particular, 0.03% (w/w) or less, 0.01% (w/w) or less, or 0.007% (w/w) or less. Specifically, the concentration of the ingredient (D) at the time of eating may be, for example, 0.00005 to 0.1% (w/w), 0.0001 to 0.03% (w/w), or 0.00014 to 0.007% (w/w).

The amount of the ingredient (D) added in the method of the present invention with respect to the total amount of the ingredients (A) to (C) added in the method of the present invention may be, for example, 1% (w/w) or more, 1.5% (w/w) or more, 2% (w/w) or more, 2.3% (w/w) or more, 5% (w/w) or more, 10% (w/w) or more, or 20% (w/w) or more, or may be 1000% (w/w) or less, 500% (w/w) or less, 200% (w/w) or less, 100% (w/w) or less, 50% (w/w) or less, 20% (w/w) or less, or 10% (w/w) or less, or may be any non-contradictory combination thereof. The amount of the ingredient (D) added in the method of the present invention with respect to the total amount of the ingredients (A) to (C) added in the method of the present invention may be, in particular, 200% (w/w) or less, 100% (w/w) or less, or 50% (w/w) or less. The amount of the ingredient (D) added in the method of the present invention with respect to the total amount of the ingredients (A) to (C) added in the method of the present invention may be, specifically, for example, 1 to 1000% (w/w), 1.5 to 200% (w/w), or 2.3 to 50% (w/w). The description on the ratio of the amount of the ingredient (D) added to the total amount of the ingredients (A) to (C) added can also be applied correspondingly to the ratio of the concentration of the ingredient (D) at the time of eating to the total concentration of the ingredients (A) to (C) at the time of eating.

The description on the addition of the active ingredients can also be applied correspondingly to the case where the composition of the present invention is added. For example, the composition of the present invention can be added to achieve the above-illustrated amounts of the active ingredients added. In the case where the composition of the present invention is added, the food of the present invention is, in other words, not only food to which the composition of the present invention has been added, but also food containing the composition of the present invention.

The food of the present invention may contain sodium chloride. That is, food of the present invention may be produced to contain sodium chloride. That is, the method of the present invention may further comprise adding sodium chloride to the raw material of food. The food containing sodium chloride may be produced, for example, by adding sodium chloride itself, or by adding materials containing sodium chloride, such as condiments containing sodium chloride. When the composition of the present invention contains sodium chloride, sodium chloride may be added by adding the composition of the present invention. Addition of sodium chloride can be performed similarly as addition of active ingredients.

The amount of sodium chloride contained in the food of the present invention can be set as appropriate depending on various conditions such as the type of the food. The food of the present invention may be food with reduced salt. The term “food with reduced salt” means food with smaller amount of sodium chloride than normal (that is, food in which the amount of sodium chloride contained is smaller than the normal amount of sodium chloride). Food containing a normal amount of sodium chloride (that is, food with a normal amount of sodium chloride contained) is also referred to as “food with normal salt content”. That is, the term “food with reduced salt” may mean, specifically, the same type of food as food with normal salt content, in which the amount of sodium chloride contained is smaller than the food with normal salt content. More specifically, the term “food with reduced salt” may mean the same type of food as food with normal salt content, in which the amount of sodium chloride contained is 0.9 times or less, 0.8 times or less, 0.7 times or less, 0.6 times or less, or 0.5 times or less than food with normal salt content. The terms “amount of sodium chloride contained” and “concentration of sodium chloride” may be used interchangeably. Examples of the food with reduced salt include foods, such as those illustrated above, which are produced to contain smaller amount of sodium chloride than normal. Examples of the food with normal salt content include foods, such as those illustrated above, which are produced to contain normal amount of sodium chloride.

In other words, the phrase “reduction of salt in food” means making the amount of sodium chloride contained in food smaller than the normal amount of sodium chloride. Specifically, the phrase “reduction of salt in food” may mean making the amount of sodium chloride contained in food smaller than the amount of sodium chloride contained in the same type of food with normal salt content. More specifically, the phrase “reduction of salt in food” may mean making the amount of sodium chloride contained in food 0.9 times or less, 0.8 times or less, 0.7 times or less, 0.6 times or less, or 0.5 times or less than the amount of sodium chloride contained in the same type of food with normal salt content.

The amount of sodium chloride contained in the food of the present invention (for example, it may be food with reduced salt) may be, for example, 0.1 times or more, 0.2 times or more, 0.3 times or more, 0.4 times or more, or 0.5 times or more, or may be 0.9 times or less, 0.8 times or less, 0.7 times or less, 0.6 times or less, or 0.5 times or less, than the normal amount of sodium chloride contained in food such as illustrated above, or may be any non-contradictory combination thereof.

The amount of sodium chloride contained in the food of the present invention (for example, it may be food with reduced salt) as a concentration at the time of eating may be, for example, 0.1% (w/w) or more, 0.2% (w/w) or more, 0.3% (w/w) or more, 0.4% (w/w) or more, 0.5% (w/w) or more, 0.6% (w/w) or more, 0.7% (w/w) or more, 0.8% (w/w) or more, 0.9% (w/w) or more, or 1% (w/w) or more, or may be 2% (w/w) or less, 1.5% (w/w) or less, 1.2% (w/w) or less, 1% (w/w) or less, 0.9% (w/w) or less, 0.8% (w/w) or less, 0.7% (w/w) or less, 0.6% (w/w) or less, or 0.5% (w/w) or less, or may be any non-contradictory combination thereof.

### <4> Use of Active Ingredients

The present invention also discloses the use of active ingredients in the applications illustrated above. That is, the present invention discloses, for example, the use of active ingredients for enhancement of the saltiness, reduction of salt in food, or production of food, and the use of active ingredients in the manufacture of a composition for enhancement of the saltiness, reduction of salt in food, or production of food.

The present invention also discloses active ingredients for use in the applications illustrated above. That is, the present invention discloses, for example, active ingredients for use in enhancement of the saltiness, reduction of salt in food, or production of food, and active ingredients for use in the manufacture of a composition for enhancement of the saltiness, reduction of salt in food, or production of food.

The present invention also discloses the use of active ingredients for use in combination of other active ingredients. Active ingredients may be used in combination of other active ingredients for the applications illustrated above.

### EXAMPLES

The present invention will now be described in more detail with reference to non-limiting examples.

The 30% nucleic acid-containing yeast extract and 5% nucleic acid-containing yeast extract used in the present examples are powder yeast extracts (both are commercially available products) containing 28 to 32% (w/w) nucleic acids and just over 5% (w/w) nucleic acids, respectively, with respect to the dry weights. The nucleic acids contained in the yeast extracts are a mixture of disodium inosinate and disodium guanylate, and the amount contained described above are the total amounts of disodium inosinate and disodium guanylate contained. Note that measurement of the amounts of disodium inosinate and disodium guanylate contained in the yeast extract by an HPLC method showed that their weight ratios (inocinic acid:guanylic acid) were 48:52 for the 30% nucleic acid-containing yeast extract, and 47:53 for the 5% nucleic acid-containing yeast extract. Both arginine and lysine hydrochloride used in the present examples are L-forms.

The raw materials were added to 100 g of hot water in the contents shown in Table 1 to prepare positive controls (PC) and negative controls (NC; about 20% reduction of salt) for a model of soba dipping sauce.

TABLE 1

| | PC | | NC | |
|---|---|---|---|---|
| | Content | NaCl | Content | NaCl |
| Raw materials | (g) | content (g) | (g) | content (g) |
| Powdered soy sauce | 0.7 | 0.24 | 0.7 | 0.24 |
| Nucleic acids | 0.2 | 0.06 | 0.2 | 0.06 |
| Nucleic acids | 0.016 | 0.00 | 0.016 | 0.00 |
| Common salt | 1.1 | 1.10 | 0.8 | 0.80 |
| Granulated sugar | 0.15 | 0.00 | 0.15 | 0.00 |
| Seasoning base | 0.1 | 0.03 | 0.1 | 0.03 |
| bonito C—CF (*) | | | | |
| Caramel color | 0.2 | 0.00 | 0.2 | 0.00 |
| Dextrin | — | — | 0.3 | 0.00 |
| | 2.466 | 1.43 | 2.466 | 1.14 |
| | | | Salt | 20.5 |
| | | | reduction | |
| | | | (%) | |

(*) Ajinomoto Co., Inc.

### (1) Evaluation of Saltiness Enhancement Effect by Nucleic Acid-Containing Yeast Extract

The ingredients shown in Table 2 were added to NC to prepare samples with test Nos. #1 to #9. In the table, “I+G (=1:1)” represents a mixture of disodium inosinate and disodium guanylate in a weight ratio of 1:1. In the table, the value for a ingredient represents the amount (g) added to 100 mL of NC. The samples were evaluated for their early, middle, and later saltiness by sensory evaluation with an expert panel. The early, middle, and later saltiness was defined as the saltiness felt between 0 seconds and 1 second, between 1 second and 3 seconds, and between 3 seconds and 5 seconds after eating (after putting food or drink in mouth), respectively. The evaluation criteria for saltiness were as follows. That is, a higher number of “+” indicates a greater effect of enhancing the saltiness.

−: showing no saltiness enhancement effect on NC;

+: showing some saltiness enhancement effect on NC;

++: showing saltiness enhancement effect on NC;

+++: showing useful saltiness enhancement effect on NC;

++++: showing very useful saltiness enhancement effect on NC; and

+++++: showing comparable saltiness intensity as PC.

Table 2 shows the results. The cases where potassium chloride, arginine, lysine hydrochloride, or each nucleic acid-containing yeast extract was added alone, and where only potassium chloride, arginine, and lysine hydrochloride were used in combination (#1 to #6) resulted in no significant saltiness enhancement effects. The case where arginine or lysine hydrochloride was not added (#10 and #11) also resulted in no significant saltiness enhancement effects. On the other hand, use of 30% nucleic acid-containing yeast extract in combination of potassium chloride, arginine, and lysine hydrochloride resulted in a significant early saltiness enhancement effect (#7). These results demonstrated that the use of the four ingredients, the nucleic acid-containing yeast extract, potassium chloride, arginine, and lysine hydrochloride in combination is important for enhancement of the early saltiness. In addition, the use of the 5% nucleic acid-containing yeast extract in combination of potassium chloride, arginine, and lysine hydrochloride resulted in no significant early saltiness enhancement effect (#8). The increase in the amount of the 5% nucleic acid-containing yeast extract added so that the amount of the nucleic acids added was equivalent to that for 30% nucleic acid-containing yeast extract resulted in no significant early saltiness enhancement effect (#9). Addition of the 5% nucleic acid-containing yeast extract and the nucleic acids in combination resulted in no significant early saltiness enhancement effect (#12). These results demonstrated that supply of the nucleic acids from the yeast extract and the use of a yeast extract containing high amounts of the nucleic acids as a source of the nucleic acids were important for enhancement of the early saltiness. Thus, it is demonstrated that the use a yeast extract containing high amounts of nucleic acids in combination with potassium chloride, arginine, and lysine was important for enhancement of the early saltiness.

TABLE 2

| Test No. | | PC | NC | #1 | #2 | #3 | #4 |
|---|---|---|---|---|---|---|---|
| Raw | Potassium chloride | | | | | 0.012 | |
| materials | Arginine | | | | | | 0.0025 |
| | Lysine hydrochloride | | | | | | |
| | 30% nucleic acid- | | | 0.0007 | | | |
| | containing yeast extract | | | | | | |
| | 5% nucleic acid- | | | | 0.0007 | | |
| | containing yeast extract | | | | | | |
| Grading | Initial saltiness | + + + + + | − | + + | + | + | + |
| | Middle saltiness | + + + + + | − | + | + | + | + |
| | Later saltiness | + + + + + | − | + | + | + | + |
| | Evaluation comment | | | | | | |

| Test No. | | #5 | #6 | #7 | #8 | #9 |
|---|---|---|---|---|---|---|
| Raw | Potassium chloride | | 0.0120 | 0.0120 | 0.0120 | 0.0120 |
| materials | Arginine | | 0.0025 | 0.0025 | 0.0025 | 0.0025 |
| | Lysine hydrochloride | 0.003 | 0.0003 | 0.0003 | 0.0003 | 0.0003 |
| | 30% nucleic acid- | | | 0.0007 | | |
| | containing yeast extract | | | | | |
| | 5% nucleic acid- | | | | 0.0007 | 0.0042 |
| | containing yeast extract | | | | | |
| Grading | Initial saltiness | + | + + | + + + + | + + | + + |
| | Middle saltiness | + | + | + + | + + + | + + + |
| | Later saltiness | + | + + | + + | + + | + + + |
| | Evaluation comment | | The | The initial | The | The |
| | | | saltiness is | saltiness is | middle | middle |
| | | | somewhat | very | saltiness is | and later |
| | | | enhanced. | usefully | usefully | saltiness is |
| | | | | enhanced. | enhanced. | usefully |

| Test No. | &# | #10 | #11 | #12 |
|---|---|---|---|---|
| Raw | Potassium chloride | 0.012 | 0.0120 | 0.0120 |
| materials | Arginine | | 0.0025 | 0.0025 |
| | Lysine hydrochloride | 0.000 | | 0.0003 |
| | 30% nucleic acid- | 0.0007 | 0.0007 | |
| | containing yeast extract | | | |
| | 5% nucleic acid- | | | 0.0007 |
| | containing yeast extract | | | |
| | I + G (=1:1) | | | 0.000175 |
| Grading | Initial saltiness | + + | + + | + + |
| | Middle saltiness | + | + + | + + + |
| | Later saltiness | + + | + + | + + |
| | Evaluation comment | | | The |
| | | | | middle |
| | | | | and later |
| | | | | saltiness is |

### (2) Investigation on Amounts of Ingredients Added

The ingredients shown in Table 3 were added to NC to prepare samples with test Nos. #1 to #7. In the table, the value for a ingredient represents the amount (g) added to 100 mL of NC. The samples were evaluated for their early, middle, and later saltiness by sensory evaluation with an expert panel using the same criteria as in (1) described above.

Table 3 shows the results. The samples in the test Nos. #2 to #7 showed significant early saltiness enhancement effects, and in particular, the samples in the test Nos. #2 to #6 showed favorable results.

TABLE 3

| Test No. | | PC | NC | #1 | #2 | #3 | #4 |
|---|---|---|---|---|---|---|---|
| Raw | Potassium chloride | | | 0.00060 | 0.00240 | 0.00600 | 0.0120 |
| materials | Arginine | | | 0.00013 | 0.00050 | 0.00125 | 0.0025 |
| | Lysine hydrochloride | | | 0.000015 | 0.00006 | 0.00015 | 0.0003 |
| | 30% nucleic acid- | | | 0.000035 | 0.00014 | 0.00035 | 0.0007 |
| | containing yeast extract | | | | | | |
| Grading | Initial saltiness | + + + + + | − | + + | + + + + | + + + + | + + + + |
| | Middle saltiness | + + + + + | − | + | + | + | + + |
| | Later saltiness | + + + + + | − | + | + + | + + | + + |
| | Evaluation comment | | | | | | |

| Test No. | | #5 | #6 | #7 |
|---|---|---|---|---|
| Raw | Potassium chloride | 0.0240 | 0.120 | 0.600 |
| materials | Arginine | 0.0050 | 0.025 | 0.125 |
| | Lysine hydrochloride | 0.0006 | 0.003 | 0.015 |
| | 30% nucleic acid- | 0.0014 | 0.007 | 0.035 |
| | containing yeast extract | | | |
| Grading | Initial saltiness | + + + + | + + + + | + + + + |
| | Middle saltiness | + + | + + | + + |
| | Later saltiness | + + | + + | + + |
| | Evaluation comment | | | Strong |
| | | | | acrid taste |
| | | | | and off- |

### (3) Investigation on Ratio of Amounts of Nucleic Acid-containing Yeast Extract and Other Ingredients Added

The ingredients shown in Table 4 were added to NC to prepare samples with test Nos. #1 to #7. In the table, the value for a ingredient represents the amount (g) added to 100 mL of NC. The samples were evaluated for their saltiness in the initial taste by sensory evaluation with an expert panel using the same criteria as in (1) described above.

Table 4 shows the results. The samples in the test Nos. #3 to #7 showed significant early saltiness enhancement effects, and in particular, the samples in the test Nos. #3 to #6 showed favorable results.

TABLE 4

| Test No. | | PC | NC | #1 | #2 | #3 | #4 |
|---|---|---|---|---|---|---|---|
| Raw | Potassium chloride | | | 0.0120 | 0.0120 | 0.0120 | 0.0120 |
| materials | Arginine | | | 0.0025 | 0.0025 | 0.0025 | 0.0025 |
| | Lysine hydrochloride | | | 0.0003 | 0.0003 | 0.0003 | 0.0003 |
| | 30% nucleic acid- | | | 0.000014 | 0.00007 | 0.00035 | 0.0007 |
| | containing yeast extract | | | | | | |
| Grading | Initial saltiness | + + + + + | − | + + | + + | + + + + | + + + + |
| | Middle saltiness | + + + + + | − | + | + | + | + + |
| | Later saltiness | + + + + + | − | + + | + + | + + | + + |
| | Evaluation comment | | | | | | |

| Test No. | | #5 | #6 | #7 |
|---|---|---|---|---|
| Raw | Potassium chloride | 0.0120 | 0.0120 | 0.0120 |
| materials | Arginine | 0.0025 | 0.0025 | 0.0025 |
| | Lysine hydrochloride | 0.0003 | 0.0003 | 0.0003 |
| | 30% nucleic acid- | 0.0014 | 0.0070 | 0.0350 |
| | containing yeast extract | | | |
| Grading | Initial saltiness | + + + + | + + + + | + + + + |
| | Middle saltiness | + + | + + | + + |
| | Later saltiness | + + | + + | + + |
| | Evaluation comment | | | Strong |
| | | | | acrid taste |
| | | | | and off- |

### INDUSTRIAL AVAILABILITY

According to the present invention, the saltiness of food can be enhanced. Enhancement of the saltiness of food is useful, for example, to compensate the lack of the saltiness of food due to reduction of salt.

1. A composition for enhancing saltiness of food, the composition comprising the following ingredients (A) to (D):
(A) potassium chloride;
(B) arginine or a salt thereof;
(C) lysine or a salt thereof; and
(D) a nucleic acid-containing yeast extract.

2. A composition for reducing salt in food, the composition comprising the following ingredients (A) to (D):
(A) potassium chloride;
(B) arginine or a salt thereof;
(C) lysine or a salt thereof; and
(D) a nucleic acid-containing yeast extract.

3. A composition for producing food, the composition comprising the following ingredients (A) to (D):
(A) potassium chloride;
(B) arginine or a salt thereof;
(C) lysine or a salt thereof; and
(D) a nucleic acid-containing yeast extract.

4. The composition according to claim 3, wherein the food to be produced is food with enhanced saltiness.

5. The composition according to claim 1, wherein the enhancement of the saltiness is enhancement of the saltiness in the initial taste.

6. The composition according to claim 3, wherein the food to be produced is food with reduced salt.

7. The composition according to claim 1, wherein the nucleic acid contained in the nucleic acid-containing yeast extract is inocinic acid or a salt thereof and/or guanylic acid or a salt thereof.

8. The composition according to claim 7, wherein the inocinic acid or the salt thereof is disodium inosinate, and the guanylic acid or the salt thereof is disodium guanylate.

9. The composition according to claim 1, wherein the amount of the nucleic acid contained in the nucleic acid-containing yeast extract is 10% (w/w) or more.

10. The composition according to claim 1, wherein the lysine or the salt thereof is lysine hydrochloride.

11. The composition according to claim 1, wherein the amount of the ingredient (D) contained in the composition is 2.3 to 50% (w/w) relative to the total amount of the ingredients (A) to (C) contained in the composition.

12. A method of enhancing saltiness of food, the method comprising:
a step of adding the following ingredients (A) to (D) to a raw material of the food:
(A) potassium chloride;
(B) arginine or a salt thereof;
(C) lysine or a salt thereof; and
(D) a nucleic acid-containing yeast extract.

13. A method of reducing salt in food, the method comprising:
a step of enhancing saltiness of the food by the method according to claim 12.

14. A method of producing food with reduced salt, the method comprising:
a step of enhancing the saltiness of the food by the method according to claim 12.

15. A method of reducing salt in food, the method comprising:
a step of adding the following ingredients (A) to (D) to a raw material of the food:
(A) potassium chloride;
(B) arginine or a salt thereof;
(C) lysine or a salt thereof; and
(D) a nucleic acid-containing yeast extract.

16. A method of producing food, the method comprising:
a step of adding the following ingredients (A) to (D) to a raw material of the food:
(A) potassium chloride;
(B) arginine or a salt thereof;
(C) lysine or a salt thereof; and
(D) a nucleic acid-containing yeast extract.

17. The method according to claim 16, wherein the food to be produced is food with enhanced saltiness.

18. The method according to claim 12, wherein the enhancement of the saltiness is enhancement of the saltiness in the initial taste.

19. The method according to claim 12, wherein the food to be produced is food with reduced salt.

20. The method according to claim 12, wherein the nucleic acid contained in the nucleic acid-containing yeast extract is inocinic acid or a salt thereof and/or guanylic acid or a salt thereof.

21. The method according to claim 20, wherein the inocinic acid or the salt thereof is disodium inosinate, and the guanylic acid or the salt thereof is disodium guanylate.

22. The method according to claim 12, wherein the amount of the nucleic acid contained in the nucleic acid-containing yeast extract is 10% (w/w) or more.

23. The method according to claim 12, wherein the lysine or the salt thereof is lysine hydrochloride.

24. The method according to claim 12, wherein the amount of the ingredient (D) added is 2.3 to 50% (w/w) relative to the total amount of the ingredients (A) to (C) added.

25. The method according to claim 12, which comprises one, two, three, or four features selected from the group consisting of the following (a) to (d):
(a) the ingredient (A) is added so that the concentration of the ingredient (A) at the time of eating is 0.0024 to 0.12% (w/w);
(b) the ingredient (B) is added so that the concentration of the ingredient (B) at the time of eating is 0.0005 to 0.025% (w/w);
(c) the ingredient (C) is added so that the concentration of the ingredient (C) at the time of eating is 0.000048 to 0.0024% (w/w); and
(d) the ingredient (D) is added so that the concentration of the ingredient (D) at the time of eating is 0.00014 to 0.007% (w/w).

26. The method according to claim 12, wherein the ingredients (A) to (D) are added by addition of a composition for enhancing saltiness of food, the composition comprising the ingredients (A) to (D).

27. Food with reduced salt, the food containing the composition according to claim 12.

28. The food according to claim 27, which has one, two, three, or four features selected from the group consisting of the following (a) to (d):
(a) the ingredient (A) is contained so that the concentration of the ingredient (A) at the time of eating is 0.0024 to 0.12% (w/w);
(b) the ingredient (B) is contained so that the concentration of the ingredient (B) at the time of eating is 0.0005 to 0.025% (w/w);
(c) the ingredient (C) is contained so that the concentration of the ingredient (C) at the time of eating is 0.000048 to 0.0024% (w/w); and
(d) the ingredient (D) is contained so that the concentration of the ingredient (D) at the time of eating is 0.00014 to 0.007% (w/w).
